(19) United States
(12) Patent Application Publication
(10) Pub. No.: US 2014/0040116 A1
(43) Pub. Date: Feb. 6, 2014

(54) TECHNIQUE FOR PERFORMING A FINANCIAL TRANSACTION

(71) Applicant: INTUIT INC., Mountain View, CA (US)

(72) Inventors: Christopher M. F. Clare, Edmonton (CA); William A. Watson, Edmonton (CA); Aaron J. Yong, Edmonton (CA); Dustin D. Durand, Edmonton (CA); Natalia E. Castagna, London (CA)

(73) Assignee: INTUIT INC., Mountain View, CA (US)

(21) Appl. No.: 13/747,256

(22) Filed: Jan. 22, 2013

Related U.S. Application Data
(60) Provisional application No. 61/678,037, filed on Jul. 31, 2012.

(51) Int. Cl. G06Q 20/32

(52) U.S. Cl. CPC G06Q 20/327
USPC 705/39

(57) ABSTRACT

During a financial technique, an instance of an application executing on an initiating electronic device initiates the financial transaction by communicating information with a receiving electronic device. Then, the application selects a financial account that provides funds for the financial transaction. This financial account may be one of multiple different types of financial accounts that are associated with different providers. Moreover, the application conducts the financial transaction by providing a message to the receiving electronic device, where the message includes an amount of funds transferred in the financial transaction. After receiving the message, an instance of the application executing on the receiving electronic device selects another financial account that receives the funds for the financial transaction, where the other financial account is one of multiple different types of financial accounts that are associated with different providers.

### CROSS REFERENCE TO RELATED APPLICATION

This application claims priority under 35 U.S.C. §119(e) to U.S. Provisional Application Ser. No. 61/678,037, entitled “Technique for Performing a Financial Transaction,” by Christopher Clare, Will Watson, Aaron Yong, Dustin Durand, and Natalia Castagna, Attorney Docket No. INTU-126926PRV, filed Jul. 31, 2012, the contents of which are herein incorporated by reference.

### FIELD

The present disclosure relates to a technique for performing a financial transaction between electronic devices.

### SUMMARY

The disclosed embodiments relate to a technique for performing a financial transaction. During this technique, an application executing on an initiating electronic device initiates the financial transaction with a receiving electronic device. Then, the application selects a financial account that provides funds for the financial transaction, where the financial account is one of multiple different types of financial accounts that are associated with different providers. Next, the application conducts the financial transaction by providing a message to the receiving electronic device, where the message includes an amount of funds transferred in the financial transaction.

Note that the initiating electronic device may be associated with an first user and the receiving electronic device may be associated with a second user. Moreover, the initiating electronic device and the receiving electronic device may or may not be proximate to each other.

In some embodiments, initiating the financial transaction involves exchanging information using: near-field communication, conveying a Quick Response code (and, more generally, a two-dimensional barcode or a graphical representation of data), and/or wireless communication. Moreover, the exchanged information includes an identifier.

Furthermore, the financial transaction may be conducted between the initiating electronic device and the receiving electronic device without involving a third party.

Another embodiment provides a method that includes at least some of the operations performed by the initiating electronic device.

Another embodiment provides a computer-program product for use with the electronic device. This computer-program product includes instructions for at least some of the operations performed by the electronic device.

Another embodiment provides a technique for performing the financial transaction. During this technique, an application executing on a receiving electronic device receives information from an initiating electronic device which initiates the financial transaction. Then, the application conducts the financial transaction by receiving the message from the initiating electronic device, wherein the message includes the amount of funds transferred in the financial transaction. Moreover, the application selects a financial account that receives the funds for the financial transaction, where the financial account is one of multiple different types of financial accounts that are associated with different providers.

Note that receiving the information from the initiating electronic device may involve: near-field communication, conveying a Quick Response code, and/or wireless communication. Moreover, the received information includes the identifier.

Another embodiment provides a second method that includes at least some of the operations performed by the other electronic device.

Another embodiment provides a second computer-program product for use with the other electronic device. This computer-program product includes instructions for at least some of the operations performed by the other electronic device.

### BRIEF DESCRIPTION OF THE FIGURES

FIG. 1 is a flow chart illustrating a method for performing the financial transaction in accordance with an embodiment of the present disclosure.

FIG. 2 is a flow chart illustrating a method for performing the financial transaction in accordance with an embodiment of the present disclosure.

FIG. 3 is a flow chart illustrating the methods of FIGS. 1 and 2 in accordance with an embodiment of the present disclosure.

FIG. 4 is a block diagram illustrating a system that performs the methods of FIGS. 1-3 in accordance with an embodiment of the present disclosure.

FIG. 5 is a block diagram illustrating an electronic device that performs the methods of FIGS. 1-3 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a technique for performing a financial transaction, and a computer-program product (e.g., software) for use with the electronic device are described. During this financial technique, an instance of an application executing on an initiating electronic device initiates the financial transaction by communicating information with a receiving electronic device. Then, the application selects a financial account that provides funds for the financial transaction. This financial account may be one of multiple different types of financial accounts that are associated with different providers. Moreover, the application conducts the financial transaction by providing a message to the receiving electronic device, where the message includes an amount of funds transferred in the financial transaction. After receiving the message, an instance of the application executing on the receiving electronic device selects another financial account that receives the funds for the financial transaction, where the other financial account is one of multiple different types of financial accounts that are associated with different providers.

By facilitating the financial transaction, this financial technique may reduce the complexity associated with performing financial transactions between electronic devices, such as portable electronic devices. For example, the financial technique may allow users to transfer funds or make a payment using a wide variety of financial accounts associated with different providers. As such, the financial technique may reduce user frustration and expense when conducting financial transactions, thereby promoting commerce.

In the discussion that follows, a user may include: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

We now describe embodiments of the financial technique. Suppose that a consumer wants to conduct a financial transaction. For example, the consumer may want to purchase something from a garage sale but may not have enough cash or the right denominations of cash. Alternatively, a charity holding a banquet may request donations but they may only accept checks and cash. In each of these examples, it may be difficult for the user to rapidly conduct a peer-to-peer financial transaction because they do not have, respectively, cash, checks or access to a credit-card processing system.

In the discussion that follows, instances of an application (which is sometimes referred to as a ‘transaction processing application’) on portable electronic devices are used to transfer funds for a financial transaction between users. This approach may be compatible with a wide variety of financial accounts (as opposed to a closed system that only works with the financial accounts associated with a particular provider). Thus, the financial technique can be used with an existing merchant system (such as a credit-card transaction system), an acquirer or payment processor, etc. As a consequence, financial transactions that include different financial accounts to provide and receive funds, respectively, may be conducted seamlessly. Moreover, the financial technique may be compatible with a wide variety of types of currency, including: electronic currency, acquirer accounts, bank accounts, etc.

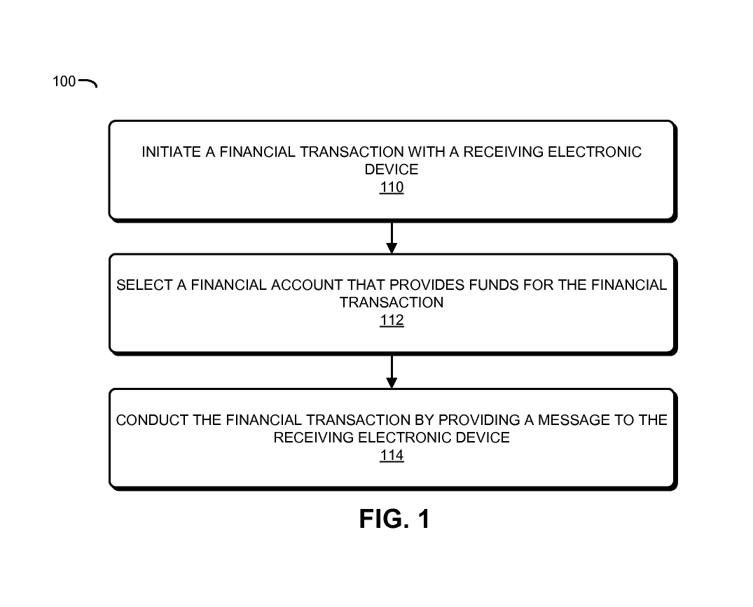

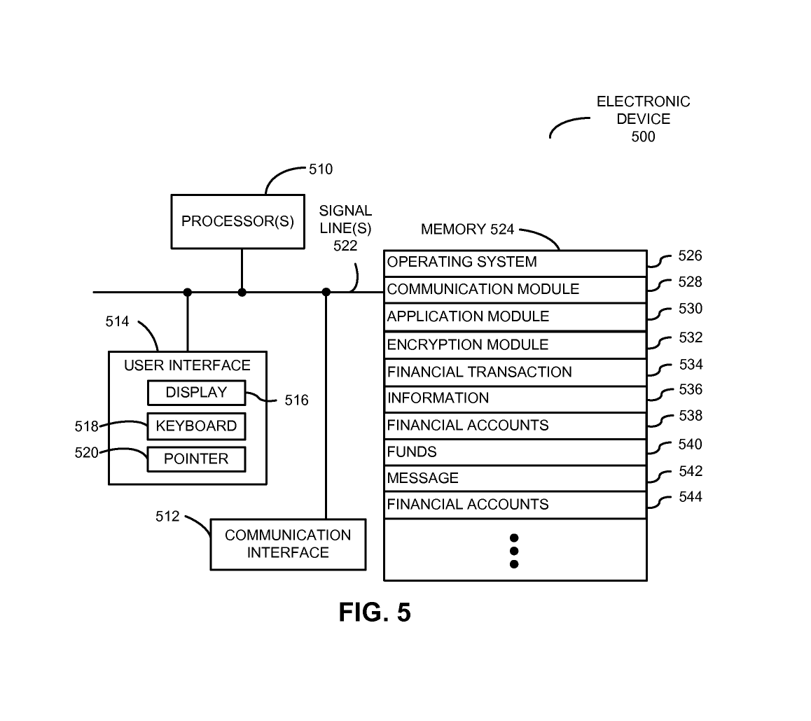

FIG. 1 presents a flow chart illustrating a method 100 for performing a financial transaction, which may be conducted by an application executing on an initiating electronic device, such as electronic device 500 (FIG. 5). During this method, an application executing on the initiating electronic device initiates the financial transaction with a receiving electronic device (operation 110). Then, the application selects a financial account that provides funds for the financial transaction (operation 112), where the financial account is one of multiple different types of financial accounts that are associated with different providers. Moreover, the application conducts the financial transaction by providing a message to the receiving electronic device (operation 114), where the message includes an amount of funds transferred in the financial transaction. More generally, the message may include information used to perform the financial transaction, such as information specifying the financial account used to provide the funds, etc.

Note that the initiating electronic device may be associated a first user and the receiving electronic device may be associated with a second user. Moreover, the initiating electronic device and the receiving electronic device may or may not be proximate to each other. For example, the financial technique may facilitate performing the financial transaction between two users that are within eyesight of each other. Furthermore, the financial transaction may be conducted between the initiating electronic device and the receiving electronic device without involving a third party.

In some embodiments, initiating the financial transaction involves exchanging information using: near-field communication, conveying a Quick Response code (and, more generally, a two-dimensional barcode or a graphical representation of data), email, a network-brokered system (such as those associated with a provider of the financial technique), and/or wireless communication. However, as is known in the art, a wide variety of communication techniques can be used. Moreover, the exchanged information includes an identifier.

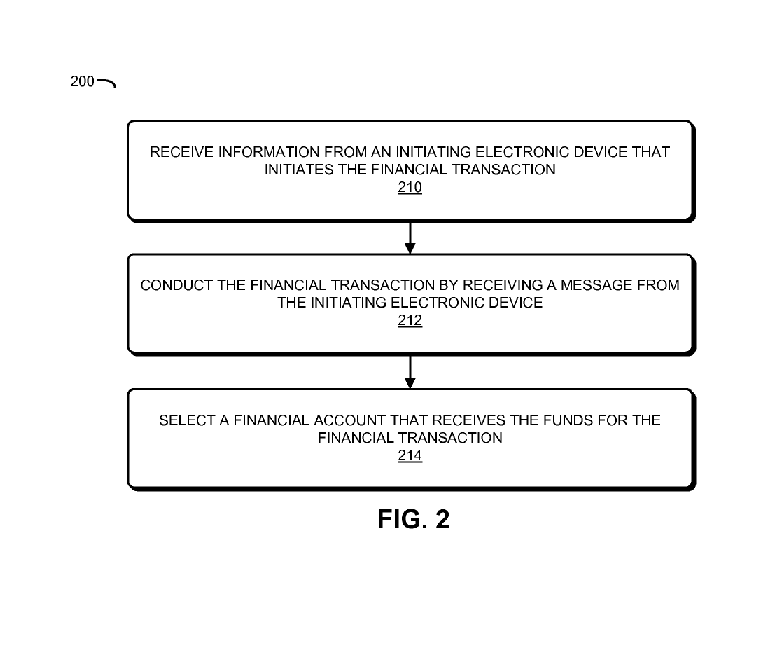

FIG. 2 presents a flow chart illustrating a method 200 for performing a financial transaction, which may be conducted by an application executing on an electronic device, such as electronic device 500 (FIG. 5). During this method, an application executing on the receiving electronic device receives a message from the initiating electronic device, which initiates the financial transaction (operation 210). Then, the application conducts the financial transaction by processing the message from the initiating electronic device (operation 212), wherein the message includes the amount of funds transferred in the financial transaction. Moreover, the application selects a financial account that receives the funds for the financial transaction (operation 214), where the financial account is one of multiple different types of financial accounts that are associated with different providers.

Note that receiving the information from the initiating electronic device may involve: near-field communication, conveying a Quick Response code (and, more generally, a two-dimensional barcode or a graphical representation of data), email, a network-brokered system, and/or wireless communication. Moreover, the received information includes the identifier.

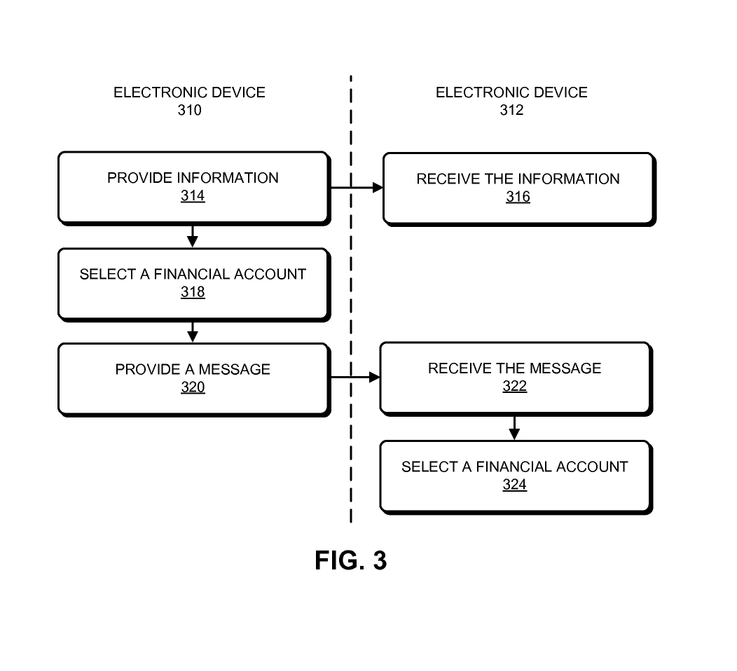

In an exemplary embodiment, the financial technique is implemented using an electronic device (such as a cellular telephone or a computer) and at least one server (which is associated with and is used by the representative), which communicate through a network, such as a cellular-telephone network and/or the Internet (e.g., using a client-server architecture). This is illustrated in FIG. 3, which presents a flow chart illustrating methods 100 (FIG. 1) and 200 (FIG. 2). During this method, a user of an application on electronic device 310 may initiate the financial transaction with electronic device 312. For example, initiating the financial transaction may involve providing information (operation 314) that is received (operation 316) by electronic device 312.

Then, the user of the application may select the financial account (operation 318) that provides the funds for the financial transaction. Moreover, the application conducts the financial transaction by providing the message (operation 320) to electronic device 312.

After receiving the message (operation 322), the user of the application selects the financial account (operation 324) that receives the funds for the financial transaction.

In some embodiments of methods 100 (FIG. 1) and 200 (FIG. 2), there may be additional or fewer operations. For example, selecting the financial accounts in operations 112 and/or 214 may be performed once by the first user and/or the second user, and then the selected financial account(s) may be the default for the application. Moreover, the order of the operations may be changed, and/or two or more operations may be combined into a single operation.

In an exemplary embodiment of the financial technique, a cloud- or network-based brokerage system is used to convey information between electronic devices to initiate a financial transaction. In addition, phone applications are used to transfer funds or provide a payment leveraging a currency system (such as one of a variety of types of currency or currency-holding systems) or a payment system. (Note that a currency system may function as an electronic wallet.) For example, a user may indicate the payment system of choice and then the funds may be withdrawn from or received in that payment system.

Furthermore, the application may facilitate an immediate financial transaction between two users via their cellular telephones. Thus, if user A wants to transfer or request money from user B, then this financial transaction may be facilitated through instances of the application on the user's cellular telephones. The financial transaction itself can be performed using near-field communication, Quick Response codes, bank- or financial-account transfers, etc., which may facilitate the exchange of information between electronic devices. Moreover, the financial transaction may be facilitated via a network-brokerage system. This brokerage system may import financial-transaction details into planning software capable of processing financial information, income-tax software capable of generating an income-tax return, and/or payroll or accounting software capable of processing payroll information.

Note that the financial technique may allow the end user or consumer to perform the financial transaction with another end user or consumer. This is in contrast with approaches that are mediated via a third party, such as a merchant. However, in some embodiment an electronic payment system is used to facilitate the financial transaction. For example, when instructed, the electronic payment system may advance funds to one end user from the other.

In an exemplary embodiment, user A may want to transfer funds to user B. For example, user A may initiate a transfer of funds to user B using: near-field communication, a Quick Response code, and/or an identifier (such as phone number, account number, etc.). Moreover, user A may specify which financial account they want to withdraw the funds from.

Then, users A and B may communicate through a connected-service system or a network-brokered system that facilitates communication, for example, on the Internet. During this communication, a message that contains the ‘value’ of the funds may be communicated between the user's electronic devices.

Furthermore, after receiving the message, user B may select the financial account in which they want to store the transferred funds.

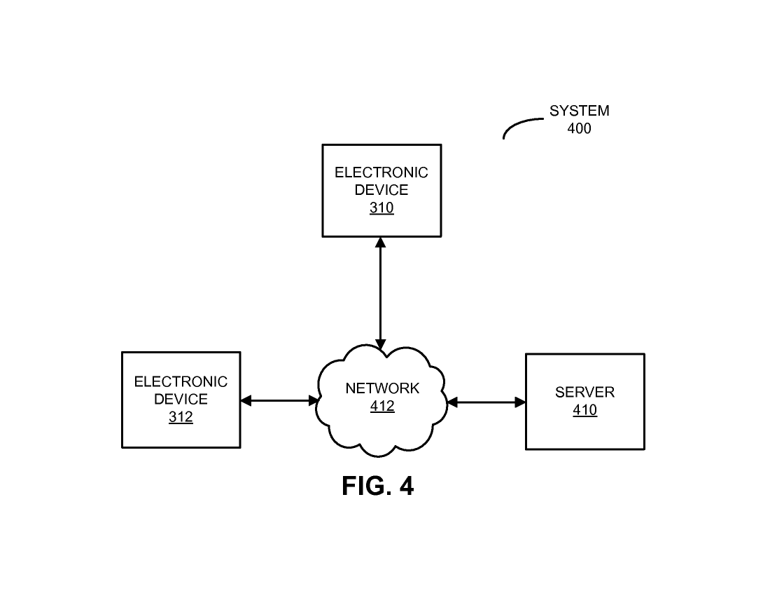

We now describe embodiments of the system and the electronic device, and their use. FIG. 4 presents a block diagram illustrating a system 400 that can be used, in part, to perform operations in methods 100 (FIG. 1) and 200 (FIG. 2). In this system, users of electronic devices 310 and 312 may use instances of a software product, such as a software application that is resident on and that executes on electronic devices 310 and 312. (Alternatively, the users may interact with a web page that is provided by server 410 via network 412, and which is rendered by a Web browser on electronic devices 310 and 312. For example, at least a portion of the software application may be an application tool that is embedded in the web page, and which executes in a virtual environment of the Web browser. Thus, the application tool may be provided to the users via a client-server architecture.) This software application may be a standalone application or a portion of instances of another application that is resident on and which executes on electronic devices 310 and 312 (such as a software application that is provided by server 410 or that is installed and which executes on electronic devices 310 and 312).

Using this software application, the user of electronic device 310 may initiate the financial transaction with electronic device 312. Then, the user of the software application on electronic device 310 may select the financial account that provides the funds for the financial transaction. Moreover, the application may conduct the financial transaction by providing the message to electronic device 312 via network 412. After receiving the message, the user of the software application on electronic device 312 selects the financial account that receives the funds for the financial transaction.

Note that information in system 400 may be stored at one or more locations in system 400 (i.e., locally or remotely). Moreover, because this data may be sensitive in nature, it may be encrypted. For example, stored data and/or data communicated via network 412 may be encrypted.

FIG. 5 presents a block diagram illustrating an electronic device 500 that performs methods 100 (FIG. 1) and 200 (FIG. 2), such as electronic device 310 (FIG. 3) or 312 (FIG. 3). Electronic device 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in electronic device 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to electronic device 500.

Memory 524 may also include multiple program modules (or sets of instructions), including: application module 530 (or a set of instructions) and/or encryption module 532 (or a set of instructions). Note that one or more of these program modules (or sets of instructions) may constitute a computer-program mechanism.

During method 100 (FIG. 1), a user of electronic device 500 may use application module 530 to initiate financial transaction 534 with the other electronic device. For example, application module 530 may send information 536 to the other electronic device using communication module 528 and communication interface 512. Then, the user may use application module 530 to select one of financial accounts 538 that provides funds 540 for financial transaction 534. Moreover, application module 530 may conduct financial transaction 534 by providing message 542 (which includes the amount of funds 540 transferred in financial transaction 534) to the other electronic device using communication module 528 and communication interface 512.

Alternatively, during method 200 (FIG. 2), a user of electronic device 500 may use communication interface 512, communication module 528 and application module 530 to receive information 536 from the electronic device, thereby initiating the financial transaction. Then, application module 530 conducts financial transaction 534 by receiving message 542 from the electronic device using communication interface 512 and communication module 528. Moreover, application module 530 selects one of financial accounts 544 that receives funds 540 for financial transaction 534.

Because information in electronic device 500 may be sensitive in nature, in some embodiments at least some of the data stored in memory 524 and/or at least some of the data communicated using communication module 528 is encrypted using encryption module 532.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510.

Although electronic device 500 is illustrated as having a number of discrete components, FIG. 5 is intended to be a functional description of the various features that may be present in electronic device 500 rather than a structural schematic of the embodiments described herein. In some embodiments, some or all of the functionality of electronic device 500 may be implemented in one or more application-specific integrated circuits (ASICs) and/or one or more digital signal processors (DSPs).

Electronic device 500, as well as electronic devices, computers and servers in system 400 (FIG. 4), may include one of a variety of devices capable of manipulating computer-readable data or communicating such data between two or more computing systems over a network, including: a personal computer, a laptop computer, a tablet computer, a mainframe computer, a portable electronic device (such as a cellular telephone or PDA), a server, a point-of-sale terminal and/or a client computer (in a client-server architecture). Moreover, network 412 (FIG. 4) may include: the Internet, World Wide Web (WWW), an intranet, a cellular-telephone network, LAN, WAN, MAN, or a combination of networks, or other technology enabling communication between computing systems.

Electronic device 310 (FIGS. 3 and 4), electronic device 312 (FIGS. 3 and 4), system 400 (FIG. 4), and/or electronic device 500 may include fewer components or additional components. Moreover, two or more components may be combined into a single component, and/or a position of one or more components may be changed. In some embodiments, the functionality of electronic device 310 (FIGS. 3 and 4), electronic device 312 (FIGS. 3 and 4), system 400 (FIG. 4) and/or electronic device 500 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An electronic-device-implemented method for performing a financial transaction, the method comprising:
using an application executing on an initiating electronic device, initiating the financial transaction with a receiving electronic device, wherein the financial transaction is a peer-to-peer financial transaction;
selecting, at the initiating electronic device, a financial account that provides funds for the financial transaction, wherein the financial account is one of multiple different types of financial accounts that are associated with different providers; and
sending a message to the receiving electronic device, wherein the message includes an amount of funds to be transferred in the financial transaction.

2. The method of claim 1, wherein the initiating electronic device is associated with a first user and the other receiving electronic device is associated with a second user.

3. The method of claim 1, wherein the initiating electronic device and the receiving electronic device communicate through a wireless communication channel and, the initiating electronic device and the receiving electronic device are within eyesight of each other.

4. The method of claim 1, wherein the initiating the financial transaction involves exchanging information using a technique selected from the group consisting of: near-field communication, conveying a Quick Response code, and wireless communication.

5. The method of claim 4, wherein the exchanged information includes an identifier.

6. (canceled)

7. A computer-program product for use in conjunction with an initiating electronic device, the computer-program product comprising a non-transitory computer-readable storage medium and a computer-program mechanism embedded therein to conduct a financial transaction, the computer-program mechanism including:
instructions for initiating the financial transaction with a receiving electronic device, wherein the financial transaction is a peer-to-peer financial transaction;
instructions for selecting, at the initiating electronic device, a financial account that provides funds for the financial transaction; and
instructions for sending a message to the receiving electronic device, wherein the message includes an amount of funds to be transferred in the financial transaction.

8. The computer-program product of claim 7, wherein the initiating the financial transaction involves exchanging information using a technique selected from the group consisting of: near-field communication, conveying a Quick Response code, and wireless communication.

9. (canceled)

10. An electronic device, comprising:
a processor;
memory; and
a program module, wherein the program module is stored in the memory and configurable to be executed by the processor to constrain represented content associated with an object in a document, the program module including:
instructions for initiating the financial transaction with a receiving electronic device, wherein the financial transaction is a peer-to-peer financial transaction;
instructions for selecting, at the initiating electronic device, a financial account that provides funds for the financial transaction; and
instructions for sending a message to the receiving electronic device, wherein the message includes an amount of funds to be transferred in the financial transaction.

11. An electronic-device-implemented method for performing a financial transaction, the method comprising:
using an application executing on a receiving electronic device, receiving information from another electronic device initiating the financial transaction, wherein the financial transaction is a peer-to-peer financial transaction;
conducting the financial transaction by receiving, at the receiving electronic device, a message from an initiating electronic device, wherein the message includes an amount of funds transferred in the financial transaction; and
selecting a financial account that receives the funds for the financial transaction, wherein the financial account is one of multiple different types of financial accounts that are associated with different providers.

12. The method of claim 11, wherein the initiating electronic device is associated with a first user and the receiving electronic device is associated with a second user.

13. The method of claim 11, wherein the initiating electronic device and the receiving electronic device communicate through a wireless communication channel and, the initiating electronic device and the receiving electronic device are within eyesight of each other.

14. The method of claim 11, wherein receiving the information from the initiating electronic device involves a technique selected from the group consisting of: near-field communication, conveying a Quick Response code, and wireless communication.

15. The method of claim 14, wherein the received information includes an identifier.

16. (canceled)

17. A computer-program product for use in conjunction with an electronic device, the computer-program product comprising a non-transitory computer-readable storage medium and a computer-program mechanism embedded therein to conduct a financial transaction, the computer-program product including:
instructions for receiving information from an initiating electronic device, which initiates the financial transaction, wherein the financial transaction is a peer-to-peer financial transaction;
instructions for conducting the financial transaction by receiving, at the receiving electronic device, a message from the initiating electronic device, wherein the message includes an amount of funds transferred in the financial transaction; and
instructions for selecting a financial account that receives the funds for the financial transaction, wherein the financial account is one of multiple different types of financial accounts that are associated with different providers.

18. The computer-program product of claim 17, wherein receiving the information from the initiating electronic device involves a technique selected from the group consisting of: near-field communication, conveying a Quick Response code, and wireless communication.

19. (canceled)

20. An electronic device, comprising:
a processor;
memory; and
a program module, wherein the program module is stored in the memory, the program module including:
instructions for receiving information from an initiating electronic device, which initiates the financial transaction, wherein the financial transaction is a peer-to-peer financial transaction;
instructions for conducting the financial transaction by receiving, at the receiving electronic device, a message from the initiating electronic device, wherein the message includes an amount of funds transferred in the financial transaction; and
instructions for selecting a financial account that receives the funds for the financial transaction, wherein the financial account is one of multiple different types of financial accounts that are associated with different providers.
